(19) United States
(12) Patent Application Publication
(10) Pub. No.: US 2012/0266429 A1
(43) Pub. Date: Oct. 25, 2012

(54) MOUNTING TOOL FOR A VEHICLE WHEEL

(76) Inventor: Sri Uripto Sugito, Jagakarsa (ID)

(21) Appl. No.: 13/518,016

(22) PCT Filed: Jul. 8, 2010
(86) PCT No.: PCT/ID2010/000008

§ 371 Date: Jul. 7, 2012

(30) Foreign Application Priority Data
Dec. 23, 2009 (ID) S00200900276

(51) Int. Cl. B60B 29/00

(52) U.S. Cl. 29/273

(57) ABSTRACT

The vehicle wheel assembler of the present invention consists of two directive sticks (1) with similar design and shape which each stick consists of an inner dredge (2) on one end of the tip. On the other end of the stick a hanginge hole (3) is provided to be hooked with a wire belt (5) in order to connect these two directive sticks. A tighter (6) is posed near the hanging hole to adjust the length of the belt. A handle (7) is posed on the middle of the belt which is a hollow-pipe shaped cartridge. The handle (7) is penetrated by said belt (5) so that it slides along said belt easily. To provide present invention to another system, an adaptor (8) with outer dredge on both tip is used.

### TECHNICAL FIELD

Present invention relates to a device to assemble wheel of vehicle consists of set of tools to ease wheel installation to a vehicle (such as sedan, truck, tractor, etc).

### BACKGROUND ART

Conventional wheel assembly has some obstacles, fitting bolts into car's rim in particular, which are located in drum of wheel (hub). This is caused by drum of wheel needs three-directions of movement at once, i.e. 1) leveraging big and heavy wheel, 2) fitting relatively small of rim into bolts located in drum of wheel, 3) pushing said wheel to its drum ward. These become harder while in a dark place. Using present invention, those conventional technique's defects will be solved quickly and easily.

### SUMMARY OF INVENTION

In order to embody present invention, it inserts two directive sticks into most upper hole and its neighbor on the rim so that penetrated, thus install dredged stick into such bolts on wheel drum (advised that to align those directive sticks with bolts of wheel drum).

After such dredged sticks attached with bolts of wheel drum, pull its handle up slowly, said wheel on directive stick slides down easily heading to wheel drum.

Using present invention, wheel assembly of vehicle will be easier and instantly.

Purpose of present invention is to ease wheel assembly on wheel drum, to work in shorter time and easy.

### SUMMARY OF FIGURE

FIG. 1 is an embodiment of wheel assembler of present invention.

FIG. 2 is another embodiment of wheel assembler of present invention (which modified specifically for big and heavy vehicles).

FIG. 3 is using direction of wheel assembler of present invention, consists of
Step 1. Close to desired wheel to wheel drum vertically with 10-15 cm distance, pose bolts of wheel drum same height as rim.
Step 2. Insert dredged directive sticks into rim hole (penetrate rim) thus install said tips into bolts of wheel drum. To smooth installation, advised to connect desired bolts to directive sticks are most height as neighbor bolts.
Step 3. Leverage said handle slowly so desired wheel slide down along with directive stick into bolts of wheel drum.
Step 4. Said wheel will be installed quickly and correctly on wheel drum as picture, then dispatch the device from said bolts.

### DETAILED DESCRIPTION

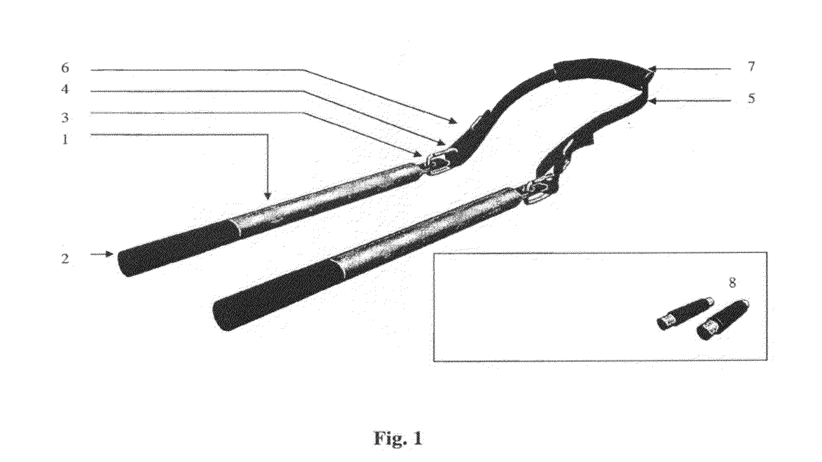

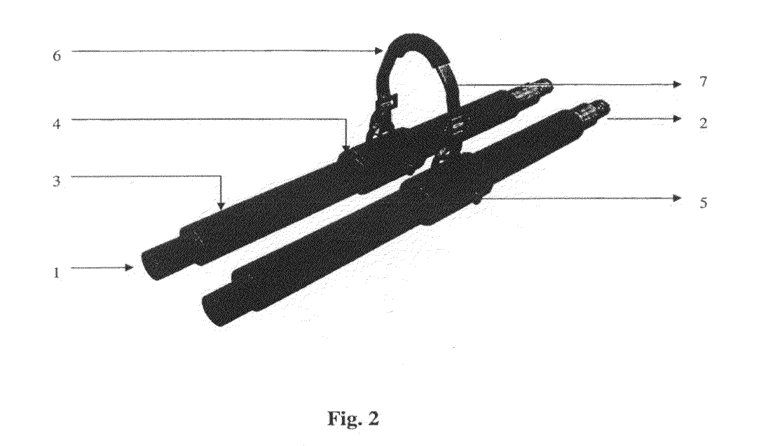

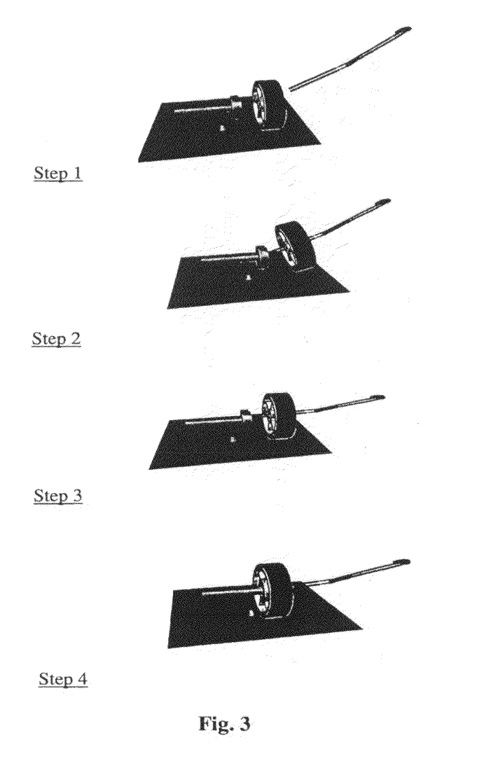

Further, present invention described in detail refers to attached FIGS. 1, 2, and 3 in which FIG. 1 shows an embodiment of vehicle wheel of assembler of present invention which consists of two directive sticks (1). This has similar design and shape each which consists of directive sticks with inner dredged (2) on its tip. Another tip has hanging hole (3), functions to be hooked (4). Pose a wire belt (5) on each hanging hole of directive sticks such that connect these two directive sticks. A tighter (6) is posed near of hanging hole to adjust its length. A handle is posed on middle of belt which is hollow-pipe shaped like cartridge (7). It is penetrated by said belt so that said handle slides along belt easily.

FIG. 3 shows instruction to utilize wheel assembler of present invention, it is to put desired wheel (8) near wheel drum (9). Take distance around 10-15 cm, penetrate two directive sticks into two holes on rim. Preferred start from most upper hole and second one. Thus insert tip of directive sticks into bolts posed on wheel drum rotationally. Make sure that those tip directive sticks installed on said bolts on wheel drum tightly. Implementing present invention, leverage said handle (7) up so that said belt (4) will be lifted and stressed. Thus desired wheel also lifted up and slide down easily follow directive stick into installed bolts on wheel drum (9). Completing said wheel, dispatch said devices by rotate tip of said directive stick.

### Symbols of Figure

1. Hardened but Flexible Directive Stick

2. Inner Dredge

3. Hooking Up Hole

4. Hook

5. Belt

6. Tighter

7. Handle

8. Adaptor

1. A wheel assembler to install a wheel into wheel drum of vehicle, characterized with two directive sticks which each stick has inner dredge. On another tip has hanging hole to hang a hook that has a belt so that join those two directive sticks. Posed a tighter on said belt functions to adjust belt's length. Also posed a handle with cartridge shaped on middle of belt that hardened and flexible in order to ease handle to move.
